(19) United States
(12) Patent Application Publication
(10) Pub. No.: US 2015/0204777 A1
(43) Pub. Date: Jul. 23, 2015

(54) Apparatus for Measuring the Relative Speed of a Golf Putting Green

(71) Applicant: Steven J. Quintavalla, Branchburg, NJ (US)

(72) Inventor: Steven J. Quintavalla, Branchburg, NJ (US)

(73) Assignee: UNITED STATES GOLF ASSOCIATION, Far Hills, NJ (US)

(21) Appl. No.: 14/616,311

(22) Filed: Feb. 6, 2015

Related U.S. Application Data
(63) Continuation-in-part of application No. 13/349,761, filed on Jan. 13, 2012, now abandoned.

(51) Int. Cl. G01N 19/02; G01P 3/24

(52) U.S. Cl. CPC G01N 19/02; G01P 3/24

(57) ABSTRACT

A green speed measuring apparatus is in the form of a longitudinal bar having inwardly inclined, longitudinally parallel surfaces on each side, to define a trough or ramp for rolling of a golf ball thereon. A standard distance of one notch on a first side is provided. In addition, on the second or obverse side, one or two additional notches are provided in the ramp thereon at different distances from the ends of the bar. Each notch is associated with a scaling factor to obtain the speed of a level green. The longest notch from one end of the bar may be marked with a scaling factor of 1.00 as the notch is located at 29.4 inches from the end; the middle notch, if located at ½ the distance of the longest notch is marked with a scaling factor of 1.83; and the shortest notch, if located at a distance of ¼ the distance of the longest notch from an end of the bar is marked with a scaling factor of 3.34. The preferred embodiment provides only a second notch on the lower side and a scaling factor of 2, and that notch is located at a distance of 13.625 inches from the end of the ramp.

### RELATED APPLICATIONS

This application claims priority upon U.S. patent application Ser. No. 13/349,761, filed Jan. 13, 2012, the disclosure of which is incorporated entirely by reference.

### FIELD OF THE DISCLOSURE, BACKGROUND OF THE INVENTION AND DESCRIPTION OF THE PRIOR ART

This invention relates to an apparatus for measuring the relative speed of a golf putting green. More particularly, this invention relates to an improvement in an existing apparatus for measuring the relative speed of a golf putting green.

As is known, the relative speed of a golf putting green can be determined using a STIMPMETER® apparatus. In this regard, the STIMPMETER® apparatus allows one to make a standard measurement of—and place a numerical figure on—the speed of a putting green. Typically, the device has been an extruded aluminum bar, 36 inches long, with a V-shaped groove extending along the entire length, a tapered end and a golf ball-release notch about 30 inches from the tapered end (the end that rests on the ground). The underside of the tapered end is milled away to reduce bounce as a rolling ball makes contact with a green. In use, the prior art bar has been laid on a green of no less than about 10 feet by 10 feet of level green surface. Then, with the ball in the notch of the groove, the bar is elevated on one end (opposite to the tapered end) to a slightly inclined position. The bar is raised until the ball starts to roll down the groove leaving the notch of the bar and coming to rest on the green inches or feet from the tapered end. This procedure is repeated two more times from the same point on the green with two more golf balls.

Assuming the balls stop within a prescribed limit of 8 inches of each other, a tee is often inserted in the green at the average stopping point of the three golf balls and the distance from the starting point is obtained.

The same procedure is repeated by positioning the end of the bar at the average tee distance and rolling three more golf balls back toward the initial starting point to obtain the distance of the average stopping point of the golf balls from the average tee. The two obtained average distances are then averaged and recorded as the “speed” of the green. In this manner, a “speed” of the green is calculated and referred to by the greens keepers and the golfers to determine the relative speed of the green, knowledge of which is often helpful in playing the game of golf.

The prior art STIMPMETER® apparatus requires a somewhat level green of an area of approximately no less than 10 feet by 10 feet. However, such a large flat area may not exist on many greens.

Accordingly, it is an object of the invention to be able to measure the speed of a green within a relatively small area of the green and, yet, without carrying around multiple devices to test greens where less than the 10 by 10 feet of level area is found.

It is another object of the invention to provide an improved STIMPMETER® device for measuring the speed of a green. It is an object of the present invention to provide a highly versatile new device for measuring speed of the green where the level area may not be at least 10 by 10 feet of even or flat area. It is a further object of the present invention to allow greens keepers to quickly and easily determine the speed of a green, even those of small flat areas, with accuracy and quickness and without the need for difficult calculations.

### SUMMARY OF THE INVENTION

Briefly, the present invention provides an apparatus for measuring the speed of a golf green, even those of small flat areas, comprised of an elongated body in the form of a bar having a pair of oppositely inclined surfaces forming a central trough area there between on each longitudinal side of the bar to thus define a pair of ramps for rolling of a golf ball thereon and off thereof and onto a green, with at least two notches on the bar—preferably one ball launching notch on at least each side of the bar so that the ball can be set therein, the bar raised, the ball rolled on and off of the trough/ramp for determining the speed of a green. The present invention is intended to allow the measuring by, for example, a greens keeper, of the speed of greens with 10 by 10 feet of level green area, as has the prior art devices, and, in addition, to measure the speed of greens with surface level areas less than 10 by 10 feet and, yet, the relative speed of the green is easily, quickly, and precisely determined by use of a simple scaling factor.

In accordance with the invention, each notch, in addition to the standard notch for greens of at least 10 by 10 of even or level green, is spaced from one end of the body at a different distance from the other notches. Different scaling factors will apply to each available notch. In accordance with the preferred embodiment of the present invention, the device is provided with a standard notch on one side, about 29.4 inches from the tapered end of the bar and a second notch, provided on the other side of the dual troughed bar, is located at precisely 13.625 inches from the tapered end. This second notch, it has been determined, while not ½ the distance from the tapered end as the standard notch, is however, highly easily useful in that the distances, when determined, after the ball rolling exercises are performed, are simply doubled and, thus, correspond to the standard “speeds” of greens calculated by use of the standard located notch. Stated another way, when the short distance notch is used as the launch point of a golf ball, a consequence of the absence of sufficient level green area of at least 10 by 10 feet, the average of the average roll distances (in both directions) are merely doubled and thus easily and directly compared to standard green speeds. The ease of merely doubling the measured distances rather than using a different scaling factor is believed highly beneficial to mass adoption of the present invention. If, however, a greens keeper were required to use an odd scale factor, by locating, for example, the second notch at either ½ or ¼ of the length of the standard notch distance, then ease of calculation would be lost and the device likely not employed.

The procedure for using the improved apparatus is the same as for a standard STIMPMETER® apparatus except that for small level areas of a green, i.e. less than 10 feet by 10 feet, each ball is rolled from a lower notch. Then, for ease of comparison, the distances are merely doubled and those correspond precisely to the speeds obtained by the standard device wherein its notch is located at 29.4 inches from the tapered end.

These and other objects and advantages of the invention will become more apparent from the following detailed description taken in conjunction with the drawings.

### BRIEF DESCRIPTION OF THE DRAWINGS

FIG. 1 is a schematic representation of the new apparatus for measuring the speed of a golf green in accordance with the invention, shown in use;

FIG. 2 is a top plan view of one side of the measuring apparatus of FIG. 1 wherein a first side is provided with a standard located notch (29.4 inches from tapered end) and the obverse or bottom side is provided with two notches for use of the device on greens with less levelness, thus requiring the use of a scaling factor to be applied to the measured distances of rolling of the ball from the notch used as the launch point;

FIG. 3A is a side view of the measuring apparatus of FIG. 2, showing three tapered or beveled ends so that the standard notch as a launch point can be used, and either of the obverse notches used, too, such that the ball will gently roll from the trough of the bar onto the green;

FIG. 3B is a side view of the preferred embodiment of the present invention, showing a first side with its notch located at the standard 29.4 inches from a first tapered end and a second notch, on the obverse side of the bar located at a different distance from its associated tapered end, preferably 13.625 inches—locations of the notches on the length of the bar is not shown to scale;

FIG. 4 is a plan view of the opposite (or obverse) side of the measuring apparatus shown in FIG. 2; and

FIG. 5 is an end view of the measuring apparatus of FIG. 1 and shows the troughs running the length of the two sides of the bar.

### DETAILED DESCRIPTION OF THE PREFERRED EMBODIMENT AND THE INVENTION

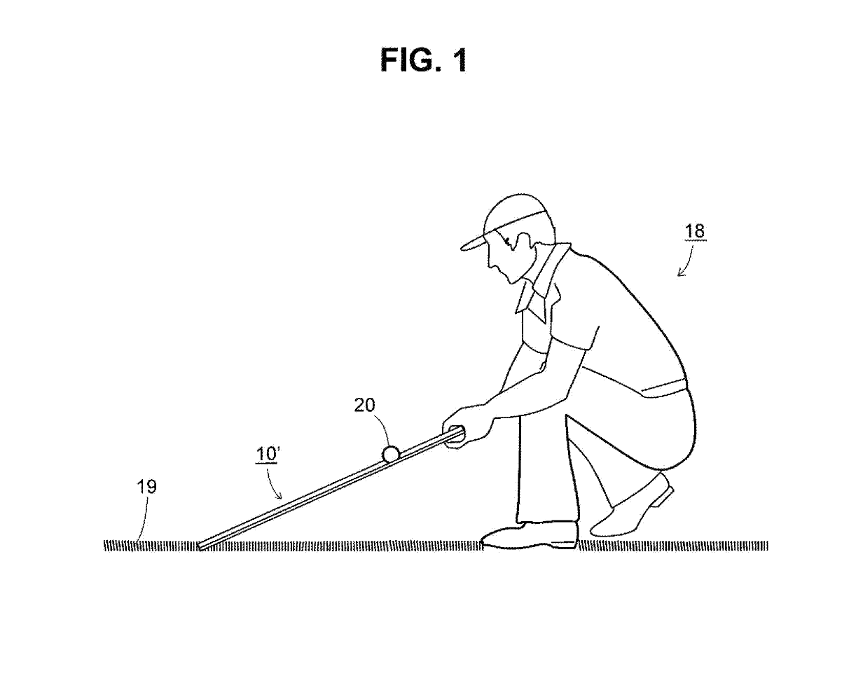

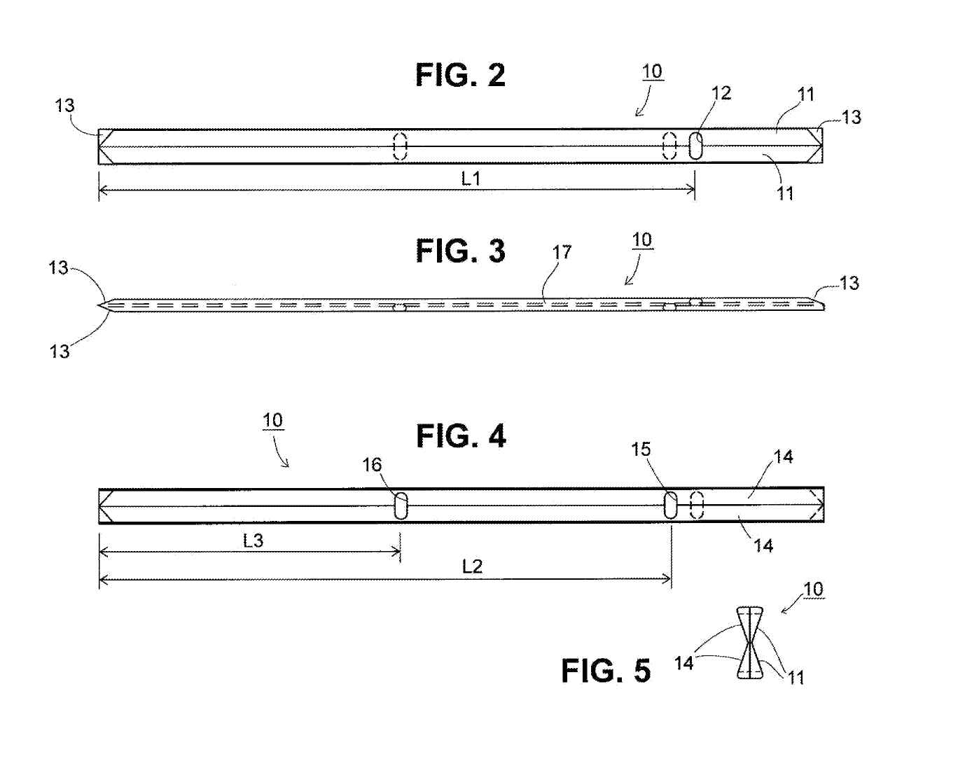

Referring first to the FIGS. 1-5, it can be easily appreciated that a longitudinal bar 10 is provided with a central trough area formed of two inclined with respect to one another surfaces 11, which are parallel (with respect to the length of the bar) to one another. When the right end of the bar opposed to the tapered end 13 (on the left side of the bar shown in FIG. 2) is gradually lifted a ball placed in notch 12 will slowly move from the notch and down the trough. The trough allows a ball to travel down its center from an aperture or notch 12. The ball will leave the trough and roll onto the green, off of a tapered end 13 of the bar 10. If the rod is constructed as the standard Stimpmeter® device, the length of the bar is about 36 inches and the front, leading or left edge of the notch (shown in FIG. 2) is located at about 29.4 inches from the tapered end 13 on the left side of the bar shown in FIG. 2. Measurements of the average of three roll distances are calculated and then a reverse direction of measurements are obtained, again with three balls launched from the aperture 12, but with the originally right side of the bar, i.e., another tapered end 13 substantially aligned with the locational average of the first three rolls. These next three rolls of the ball are directed back toward the original starting point of the first set of three rolled balls. The ball 20 is placed in the same first notch, a standard 29.4 inches from the tapered end of the bar (on a bar of about a total of 36 inches in length) and the bar gently elevated on the left end (opposite the tapered end which is now located on the right as the bar is reversed in position) allowing the ball to gently slide from trough onto green) until the ball starts to roll down the trough and onto the green. Measurements are again taken on 3 such rolls and the average roll length is recorded. Then an average derived from the average distances of the first three rolls and the second (opposed in direction) three rolls. This is referred to as the green speed (in feet).

However, according to current and acceptable methods of use, the prior art and standard Stimpmeter® bar/device, with its notch located about 29.4 inches from a tapered end, is to be used only on substantially level green surface areas of no less than about 10 by 10 feet. Thus, there are surely instances where such a large and level surface is not present on the green and, yet, standard relative speeds of the greens are desired to be known so that a player can gauge the same, before his ball hits onto the green. Surely, green speed is a factor for a player to consider when playing a course or hole of a course. The present invention is a new and improved device and thus provides a mechanism for allowing the determination, in a simple, quick, and substantially conventional manner, of green speeds, using the same measure (feet) for comparison and, yet, the device is meant to alternatively be useful where the green being measured is less than the desired 10 by 10 feet of level green surface. The present invention will provide a speed of green where less than 10 by 10 of even or level green is present. A smaller distance of rolling on the bar (within the trough) is thus provided—so that the ball comes to rest within the actual (yet smaller) level area of the green and is not affected by undulations of the green itself. This is precisely what is accomplished, easily, simply and with repeated and accurate yet comparable results, for green speed standardization. The present invention provides a green speed measuring device for 10 by 10 or more level green areas and, alternatively, the same device can be used for those greens not having the 10 by 10 feet of level surface area. Yet, as a consequence of the present invention, the bar is alternatively used as the standard Stimpmeter® device with its well-known distance units as a measure of green speed and/or alternatively, as a Stimpmeter® bar or device for use with greens without 10 by 10 feet of level surface area. An important aspect of the present invention is that use of the device for smaller surface areas than the desired 10 by 10 feet of level green will still provide a measurement in feet which is easily computable and thus able to be directly used by a greens keeper and/or player, as he/she is already familiar with speeds of green as determined by the standard Stimpmeter® device. A further important aspect of the current invention is that in being two-sided, the presence of a second or third release notch does not interfere with the smooth roll of a ball from the notch located at 29.4 inches from the tapered end (13). It is an important aspect of the present invention that use of the alternative side of the device is easy to use, employs the same basic methodology, and that while a smaller roll distance may be measured, it is simple, quick, does not require a calculation but for a mere doubling of the average to transform the measured distance to the well-known and thus easy to appreciate speed of green, as determined by the standard Stimpmeter® device.

According to FIG. 2, the new apparatus for measuring the speed of a golf green comprises an elongated body 10 in the preferred form of an aluminum bar having a length of 36 inches, a width of 1.75 inches and a thickness of 0.625 inches at a lateral edge (see FIG. 5). One longitudinal side of the body 10 has a pair of oppositely inclined (yet parallel to the overall length of the bar) surfaces 11 that define a ramp for rolling of a golf ball 20 thereon (See FIG. 1). The inclined surfaces define an included angle of 145° (see FIG. 5). This first or upper side of the body 10 also has a preferred oval shaped notch 12 spaced a predetermined distance (L1) from the tapered end 13 (on the left of the device as seen in FIG. 2) of the body 10, i.e. a distance of 29.4 inches. In discussing the distances of the apertures or notches 12, 15 and 16 herein, it will be appreciated that the distances L1, L2, and L3 are measured from the end of the tapered end off which the ball will roll to the nearest edge of that notch.

The notch 12 on the top or first side of the bar 10 is centrally located across the width of the bar, and is of conventional size, e.g. having a width of 1.25 inches across the body 10 and with a height of 0.594 inches extending longitudinally of the body 10.

The body 10 has a tapered surface 13 (on the left side of FIG. 2). That downwardly tapered surface is provided so that the bar can be upwardly tilted, with the tapered end maintained on the green, the right side slowly elevated until the ball leaves the notch as a consequence of gravity, and, yet, the ball will slowly and gently roll onto the green rather than jump or bounce as the ball exits the bar. Thus, the tapered end at the left side of the bar shown in FIG. 2 rests upon the green and allows the end of the bar to lie flat against a level green surface and the ball to gently roll off of the bar.

FIG. 3A is a side view of the bar with a single and standard located notch on the top or first side, i.e., 29.4 inches from the tapered end on the left side of the bar shown in FIG. 2. In addition, it will be appreciated that according to this embodiment of the present invention, the obverse or second/under side of the bar is provided with an additional trough and a pair of notches for use when the standard 10 by 10 feet of level green surface area is not present. A shorter ramp length is thus “called for” and available. In this embodiment, as well as that shown in FIG. 3B, the right side of the bar is also provided with a tapered end so that the ball rolling off of that side will also gently roll onto the green (without bounce nor a jump). This is also labeled as element 13, a tapered end of the bar opposite the first tapered end 13 on the left side of the bar. In addition, as can be seen in FIG. 3A, because not one but two notches are provided on the second, obverse or underside of the bar, allowing for two ball release points for use with small and even smaller green level surfaces (less than 10 by 10 of level green is available) both ends of the bar are provided, on the top side (which is in contact with the green when the device is flipped for use of the second or obverse or under side) with downwardly sloped or tapered ends to facilitate ball rolling off of the bar when either of the ends are slowly lifted for launching the ball. Thus, as seen in FIG. 3A, the left side of the bar has a pair of mirror image tapered surfaces so that notch 12 or 16 can be used while the right side of the bar is provided with a single notch 15 and downwardly tapered or sloped end 13 for use when the ball is rolled off of the bar from lifting the left side with the right side maintained on the green. There, a tapered end 13 will also ensure a smooth roll of the ball off of the trough and onto the green.

FIGS. 2, 3A and 4, shows an embodiment of the present invention wherein a single notch 12 at the standard location for use on a green with a level area of no less than about 10 by 10 feet is provided on the top, first or upper surface with the tapered end on the left side of the bar. In addition, in this embodiment, a notch 15 is located on the second, obverse or lower side of the bar, at a distance of about 7.345 from the tapered end on the right side of the bar shown in FIGS. 2, 3A and 4. Thus L2, measured from the tapered end 13 on the right side of the bar shown in FIGS. 2, 3A and 4, extends to the beginning of the notch, i.e., the edge of the notch closest to the tapered end off of which a ball is intended to roll when placed in that notch. A tapered end is provided to allow the ball to gently roll onto the surface of the green whether the ball is rolled from notch 12 (onto green via tapered end on the left side of the bar shown in FIGS. 2, 3A and 4) and a tapered or sloped end 13 is also provided on the right side of the bar shown in FIGS. 2, 3A and 4, allowing the ball to exit notch 15 and to gently roll onto the green.

Referring to FIG. 4, the second, obverse or lower longitudinal side of the body 10 has a pair of oppositely inclined (to form a central trough) parallel surfaces 14 defining a second ramp for rolling of a golf ball thereon as well as, in one embodiment, two notches 15, 16. Each of these notches 15, 16 is of the same size as the notch 12 on the first, top side of the body 10 yet spaced at different and predetermined fractional distances from the end of the body 10 as that of the distance of the first notch 12. As shown, one notch 16 is spaced a distance (L3) measured from tapered end on the left side of the bar to the leading edge of the notch of 14.69 inches from one tapered end of the body and the other notch 15 is spaced half that distance (L2) from the opposite end of the body 10, i.e. a distance of 7.345 inches. Thus, one notch 12 provides a standard notch as in a standard STIMPMETER® apparatus, a second notch 16 is located one-half the distance of the distance of the location of the standard notch 12 and the third notch 15 is located one-quarter the distance of the standard notch 12 or about 7.345 inches from its associated tapered end. When balls are released from notch 12, no scaling factor is applied to the average measurements in determining relative green speed. However, when the balls are launched from notch 16, a scaling or multiplying factor of 1.83 is used to provide a comparable speed of the green while a scaling or multiplying factor of 3.34 is used for distances measured when the balls are released from notch 15. In this connection, the scaling factor is merely a multiplier of the measured averages to arrive at a new distance which is comparable to the distances or green speed measured by use of the notch 12. So, for example, if the measured average distances of the balls rolling off of the second, obverse or lower bar's trough where the ball is located in notch 16, is 10 feet, then 10 times 1.34 (notch 16's scaling factor) or about 13.4 feet is the speed of the green. If the balls are launched from notch 15, however, and they travel about 4.5 feet after averaging, then the scale factor of 3.34 is used and thus 4.5 times 3.34 results in a speed of the green of about 15.03. Yet, it will be appreciated that use of the various scaling factors, even if printed onto the side of the bar for ease of access, may require some calculation by the measurer which is easily miscalculated and/or at the least, is time consuming and not easy to derive.

For this reason, the present invention has a preferred embodiment where the scaling factor is a simple 2.0 or doubling. Yet, counter intuitively, this scaling factor does not correspond to a notch location ½ that of the standard distance of notch 12 but, rather, the notch for use of the simple 2.0 scaling factor is located at 13.625 inches from its associated tapered end. Thus, a preferred and simple embodiment of the present preferred invention contemplates the use, on one side of the bar, of the standard notch 12, at its standard 29.4 inches from the tapered end on the left side of the Fig. and a new, singular and second notch, 16 or 15, located on the obverse, second or lower side of the bar, at a distance 13.625 inches from its associated tapered end. If the notch on the second or lower side is at 16, then the left side of the bar will have the dually tapered or sloped end shown in FIG. 3A. If the notch on the second or lower side is at 15, then the right side of the bar will have the downwardly sloped (when the bar is inverted) singly tapered side 13 and the upper or first side will still have a tapered side 13 but the two tapered sides will be on opposite sides of the bar (as seen in FIG. 3B). According to the present invention, the preferred embodiment contemplates the standard Stimpmeter® on a first side with notch 12 located at about 29.4 inches from tapered end on the left side as seen in FIG. 2, while the second or obverse side has a single notch 15, located at 13.625 inches from the tapered end on the right side of the bar. When the standard side of the bar is used, no scaling factor or multiplier is employed to derive speed of green. However, if the balls are launched from notch 15, a multiplier of 2.0 is easily computed by the measurer and this then corresponds to standard speeds of green. Thus, a single device, with both standard and a new notch location on the second or obverse side is provided which allows measurement of speed of greens both greater than 10 by 10 feet of level green and smaller than 10 by 10 of level green, all while not “taxing” the abilities of the greens keepers since they merely multiply the results obtained by the distances of rolling from notch 15 by 2×. This is simple, easy and convenient.

Referring to FIGS. 3A and 3B, the body 10 has a lateral side 17 that is of uniform thickness throughout the length thereof.

Testing has shown that using the shorter heights associated with the alternative notches 15, 16 (located at distances 7.345 and 14.69 from the tapered or sloped ends, can be used to predict the traditional Stimpmeter reading. However they require a scaling factor multiplier which is not as easy to employ as the 2× multiplier useful with a notch located at 13.625 inches from the tapered end. Accordingly, the “shortest” ramp, i.e. the section of ramp from the notch 15, requires the user to multiply the results by about 3.34 and the “middle” length ramp, i.e. the ramp section from the notch 16, requires the user to multiply the results by about 1.83 in order to obtain the “original” or relatively comparable Stimpmeter readings. But, significantly, by locating a single notch 16 on the second or obverse side of the bar, at a location of 13.625, it has been determined that a scaling or multiplying factor of 2× can be used. This is a significant advantage of the present invention, in its preferred embodiment.

The body 10 can be marked with a plurality of scaling factors on a flat lateral side 17, each scaling factor corresponding to a respective one of the notches 12, 15, 16.

For example, the standard notch 12 is marked (along with an arrow showing direction of ball rolling down the trough) with a scaling factor of 1.00, the middle notch 16 is marked with a scaling factor of 1.83 and an arrow directed toward its associated tapered end, and the shortest trough associated with notch 15 is marked with a scaling factor of 3.34. Where the second or obverse side is provided with the notch 16 located at 13.625 inches from its associated tapered or sloped end 13, the side of the bar can be imprinted with scaling factor “2×” along with an arrow showing direction of ball rolling off of the end of the bar. Thus the preferred embodiment has a notch on a standard length bar like that of the current standard Stimpmeter device and a single notch on its second, lower or obverse side located at 13.625 inches from its tapered end, preferably an end of the bar opposite to the tapered end for the roll off of the ball from the standard notch on the upper or first side, located 29.4 inches from the notch 12.

The body 10 may also have a scale printed thereon (not shown) for measuring ball roll distance, the scale running on the opposite flat lateral side 17 from the side of the bar showing the multiplying scaling factors. This can be in inches and fractions or portions of inches.

Referring to FIG. 1, the body 10 is manually employed by a user 18 to measure the speed of a green 19 by inclining the body of the bar with a golf ball 20 in a selected notch 12, 15, 16 of the body 10. For a large area of level green, i.e. of at least 10 feet by 10 feet, each golf ball of a set of three golf balls is positioned in and rolled from the single notch 12 located on the first, standard or upper side of the body 10 in accordance with the standard procedure for a STIMPMETER® apparatus.

For use on a green of a small level area, i.e. of less than 10 feet by 10 feet, the body 10 is turned over to present a shorter ramp down which a ball may roll. The body 10 is invertible and reversible so that a ball 20 may be rolled from one of two different heights depending on the smallness of the green area being tested. If the notches are located at distances of 14.7 and 7.345 from their respective tapered or sloped ends, then scaling factors of 1.83 and 3.34 are used. If, however, the notch on the second, obverse or lower side is used and located at about 13.625 from its tapered or sloped end 13, then the most simple scaling factor of 2× is used.

For a relatively small area of level green, the average distance resulting from a ball 20 being rolled down the body 10 from the “shortest” ramp 15 is obtained using the standard steps for a standard STIMPMETER® apparatus. This averaged distance is then multiplied by a scaling factor of 3.34 or 2.0 (depending upon location of the notch) to obtain the speed of the green.

For a larger size of level green, the average distance resulting from a ball 20 being rolled down the body 10 from the “middle” ramp 16 is obtained using the standard steps for a standard STIMPMETER® apparatus. This averaged distance is then multiplied by a scaling factor of 1.83 to obtain the speed of the green.

The invention thus provides a measuring apparatus that is able to measure the speed of a level green within a relatively small area of the green.

The invention further provides an improved STIMPMETER® apparatus for measuring the speed of a green using a relatively small level area of the green.

What is claimed is:

1. An apparatus for measuring the speed of a golf green comprising
an elongated bar having a pair of oppositely inclined parallel surfaces forming a trough on one longitudinal side for rolling of a golf ball thereon when said trough is held at an angle to a golf green, a pair of oppositely inclined parallel surfaces on an opposite longitudinal side defining a second trough for rolling of a golf ball thereon when said trough is held at an angle to a gold green, a first notch in said first trough for positioning a golf ball therein, said first notch being located at about 29.4 inches from a first end of said elongated body, and a second notch in said second trough for positioning a golf ball therein, said second notch being located at a partial distance to said first notch location.

2. An apparatus as set forth in claim 1 wherein said second notch is located from an end of said bar at a fraction of either ½ or ¼ of the distance of said first notch from said first end.

3. An apparatus as set forth in claim 2 wherein a scaling factor of 1.83 is used for measuring standardized green speed when balls are rolled from the notch located at ½ of the distance of said first notch from said first end.

4. An apparatus as set forth in claim 2 wherein a scaling factor of 3.34 is used for measuring standardized green speed when balls are rolled from the notch located at ¼ of the distance of said first notch from said first end.

5. An apparatus as set forth in claim 1 wherein said second notch is located at a distance of 13.625 inches from an end of bar and a scaling factor of 2 is used for measuring standardized green speed when balls are rolled from the second notch.

6. An apparatus as set forth in claim 3 further comprising a scaling factor marked on said body along the side of said bar.

7. An apparatus as set forth in claim 6 further comprising visible markings on the side of said bar for facilitating measurements of distance.

8. An apparatus as set forth in claim 1 further having a third notch in said second ramp spaced a different distance from the end of said bar as said second notch.

9. An apparatus as set forth in claim 8 further comprising a plurality of scaling factors marked on said body, each said scaling factor corresponding to a respective one of said first notch, said second notch and said third notch.
